(19) United States
(12) Patent Application Publication
(10) Pub. No.: US 2008/0152853 A1
(43) Pub. Date: Jun. 26, 2008

(54) COMPOSITE CONTAINMENT CASINGS FOR TURBINE ENGINE AND METHODS FOR FABRICATING THE SAME

(76) Inventors: Lee Alan Blanton, Cincinnati, OH (US); Stephen Mark Whiteker, Covington, KY (US); Matthew Bernard Buczek, West Chester, OH (US); Warren Ronk, West Chester, OH (US); Curt Brian Curtis, West Chester, OH (US); David Scott Miller, Cincinnati, OH (US)

Correspondence Address: JOHN S. BEULICK (12729);C/O ARMSTRONG TEASDALE LLP, ONE METROPOLITAN SQUARE, SUITE 2600, ST. LOUIS, MO, 63102-2740, US

(21) Appl. No.: 11/614,439

(22) Filed: Dec. 21, 2006

(51) Int. Cl. B05D 3/12; B28B 23/02

(52) U.S. Cl. 428/36.4; 427/350

(57) ABSTRACT

A method for fabricating a turbine engine composite containment casing is provided. The method comprising impregnating a plurality of fiber-reinforced layers with a resin to form a preform, heating the preform to a first temperature, applying a vacuum to the preform, varying an amount of pressure applied to the preform when the temperature reaches the first temperature, heating the preform from the first temperature to a second temperature at a first temperature rate, and heating the preform from the second temperature to a third temperature at a second temperature rate to facilitate curing of the preform.

### BACKGROUND OF THE INVENTION

This invention relates generally to turbine engines, and more particularly, to composite fan containment casings used with turbine engines and methods for fabricating such casings.

At least some known gas turbine engines include high and low pressure compressors, a combustor, and at least one turbine. The compressors compress air which is mixed with fuel and channeled to the combustor. The fuel/air mixture is then ignited to generate hot combustion gases, which are channeled to the turbine.

When engines operate in various conditions, foreign objects may be ingested into the engine. More specifically, various types of foreign objects, ranging from large birds, such as sea gulls, to hailstones, sand and rain, may be entrained in the inlet of a gas turbine engine. The foreign objects may impact a blade causing a portion of the impacted blade to be torn loose from a rotor. Such a condition, known as foreign object damage, may cause the rotor blade to pierce an engine casing which may result in cracks along an exterior surface of the engine casing, and/or possible injury to nearby personnel. To facilitate preventing engine casing damage and injuries to personnel, at least some known engines include a casing shell to facilitate preventing crack propagation under impact loading and to facilitate reducing stresses near the engine casing penetration.

Known methods of fabricating such engine casings use a resin film infusion process that involves applying resin to layers of fiber-reinforced material and curing the resin to create a preform. During the curing cycle, however, achieving uniform resin distribution through the reinforcing fiber material and around complex parts may be difficult. Moreover, in known resin infusion processes, air pockets may develop within the resin and/or reinforcing fiber material. Such air pockets can reduce the structural integrity of the preform.

### BRIEF DESCRIPTION OF THE INVENTION

In one aspect, a method for fabricating a turbine engine composite containment casing is provided. The method comprising impregnating a plurality of fiber-reinforced layers with a resin to form a preform, heating the preform to a first temperature, applying a vacuum to the preform, varying an amount of pressure applied to the preform when the temperature reaches the first temperature, heating the preform from the first temperature to a second temperature at a first temperature rate, and heating the preform from the second temperature to a third temperature at a second temperature rate to facilitate curing of the preform.

In another aspect, a composite containment casing for a turbine engine is provided. The casing is fabricated by forming a fiber-reinforced mat comprising a plurality of layers of braided reinforcing fibers, impregnating the fiber-reinforced mat with a resin to form a preform, inserting the perform into a bag, heating the bag and perform to a first temperature, applying a vacuum to the bag and preform, varying an amount of pressure applied to the bag and preform when the temperature reaches the first temperature, heating the bag and preform from the first temperature to a second temperature at a first temperature rate, and heating the bag and preform from the second temperature to a third temperature at a second temperature rate to facilitate curing the preform.

### BRIEF DESCRIPTION OF THE DRAWINGS

FIG. 1 is a schematic illustration of an exemplary gas turbine engine.

FIG. 2 is an enlarged cross-sectional view of an exemplary fan containment casing that may be used with the gas turbine engine shown in FIG. 1.

FIG. 3 is an enlarged schematic cross-sectional view of a portion of the fan containment case shown in FIG. 2.

FIG. 4 is a flowchart illustrating an exemplary method for fabricating the fan containment casing shown in FIG. 2.

FIG. 5 is a graphical illustration of the exemplary method shown in FIG. 4.

### DETAILED DESCRIPTION OF THE INVENTION

A composite fan casing for a gas turbine engine is described below in detail. In the exemplary embodiment, the casing includes a core having a plurality of core layers of reinforcing fiber bonded together with a thermosetting polymeric resin. The composite casing resists crack propagation under impact loading. Specifically, during an impact, kinetic energy is dissipated by delamination of the core casing layers which then capture and contain the impact objects.

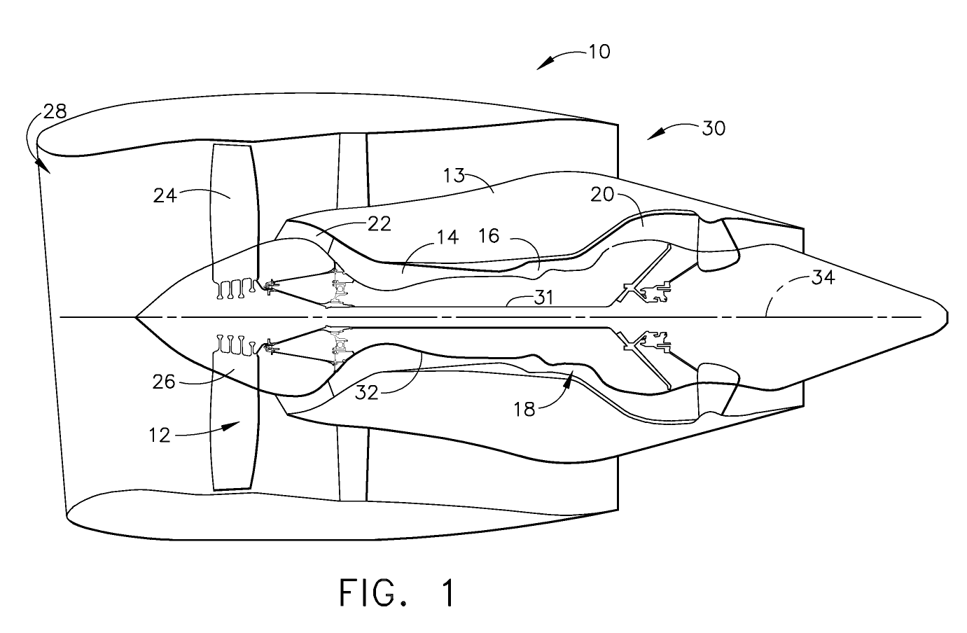

Referring to the drawings, FIG. 1 is a schematic illustration of an exemplary gas turbine engine 10 that includes a fan assembly 12 and a core engine 13 including a high pressure compressor 14 and a combustor 16. Engine 10 also includes a high pressure turbine 18, a low pressure turbine 20 and a booster 22. Fan assembly 12 includes an array of fan blades 24 extending radially outward from a rotor disc 26. Engine 10 has an intake side 28 and an exhaust side 30. In one embodiment, the gas turbine engine is a GE90 available from General Electric Company, Cincinnati, Ohio. Fan assembly 12 and turbine 20 are coupled by a first rotor shaft 31, and compressor 14 and turbine 18 are coupled by a second rotor shaft 32.

During operation, air flows through fan assembly 12, along a central axis 34, and compressed air is supplied to high pressure compressor 14. The highly compressed air is delivered to combustor 16. Airflow (not shown in FIG. 1) from combustor 16 drives turbines 18 and 20, and turbine 20 drives fan assembly 12 by way of shaft 31.

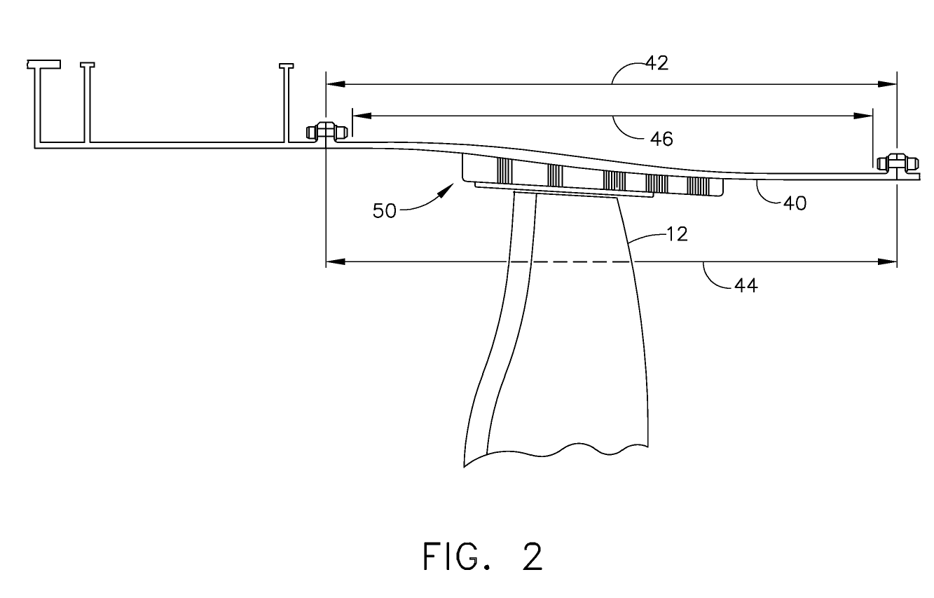

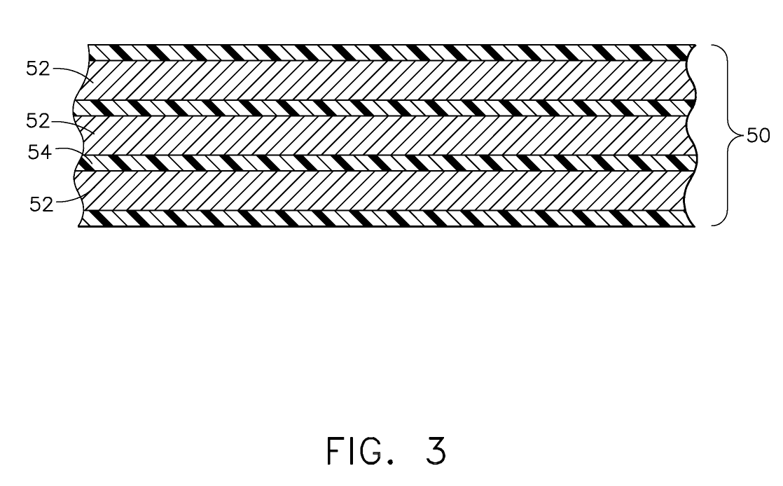

FIG. 2 is an enlarged schematic cross-sectional view of an exemplary fan containment casing 40. FIG. 3 is an enlarged schematic cross-sectional view of a portion of fan containment casing 40. In the exemplary embodiment, engine containment casing 40 is a hardwall containment system having a length 42 that is selected to be approximately equal to a fan assembly length 44. More specifically, length 42 is variably selected to ensure fan containment case 40 substantially circumscribes a prime containment width 46 of fan assembly 12. As used herein, the prime containment width 46 is defined by a zone that extends both axially and circumferentially around fan assembly 12 in an area where a fan blade, such as blade 24 (shown in FIG. 1) is most likely to be ejected from fan assembly 12.

In the exemplary embodiment, containment casing 40 includes a core 50 that is fabricated in part by a plurality of core layers 52 of reinforcing fibers. Moreover, in the exemplary embodiment, core layers 52 of reinforced fibers are bonded together by a thermoset resin 54 to form a mat (not shown). In an alternative embodiment, each core layer 52 includes a plurality of braids of reinforced fibers. Specifically, in this alternative embodiment, the reinforcing fibers are braided into a braided mat where the braids are substantially aligned to extend in a circumferential direction. More specifically, the braids are formed by braiding fiber tows (not shown) containing between about 10,000 to about 30,000 fibers per tow. In alternate embodiments, the fiber tows can contain less than about 10,000 fibers, or greater than about 30,000 fibers. However, the strength of core 50 is reduced when the tows contain less than 10,000 fibers, and the weight of containment casing 40 increases when fiber tows contain greater than 30,000 fibers.

Any suitable reinforcing fiber can be used to form the fiber tows in core layers 52, including, but not limited to, glass fibers, graphite fibers, carbon fibers, ceramic fibers, aromatic polyamid fibers, for example poly(p-phenylenetherephtalamide) fibers (KEVLAR® fibers), and mixtures thereof. Any suitable thermosetting polymeric resin can be used in forming core 50, for example, vinyl ester resin, polyester resins, acrylic resins, epoxy resins, polyurethane resins, polyimide, bismaleimide, and mixtures thereof.

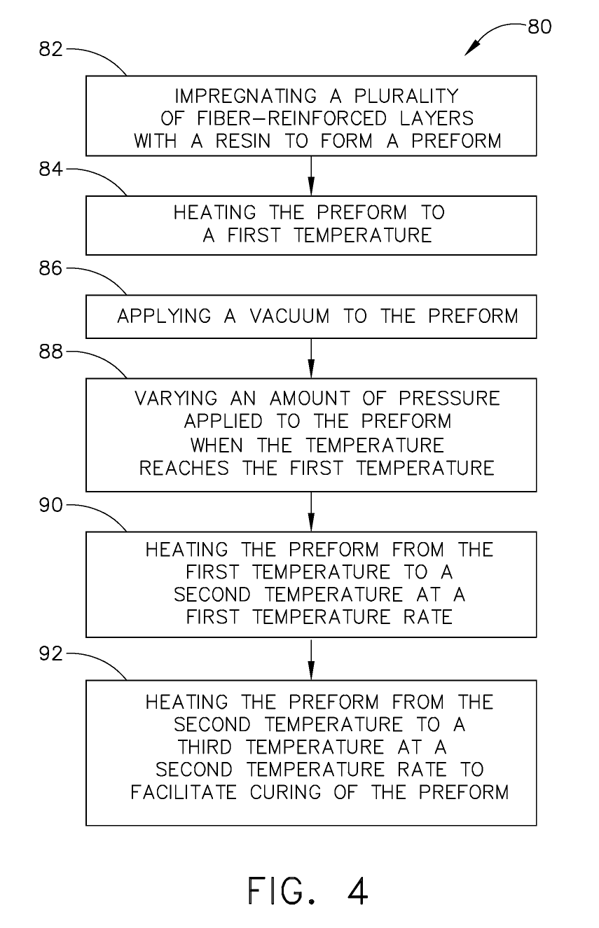

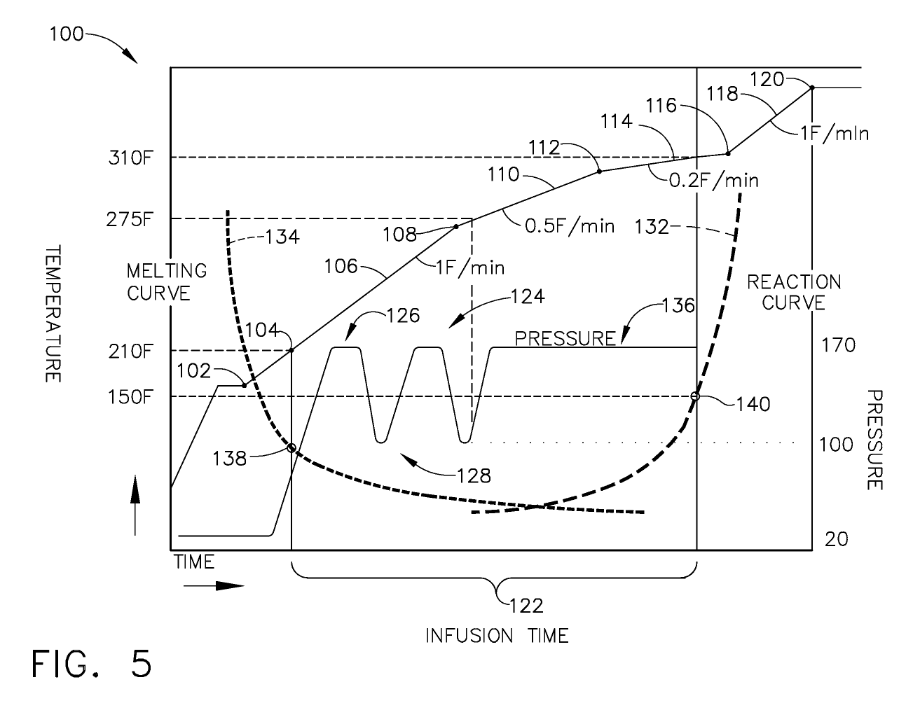

FIG. 4 is a flowchart illustrating an exemplary method 80 of a curing cycle 100 that may be used to fabricate turbine engine composite casing 40 shown in FIG. 2. FIG. 5 is a graphical illustration of method 80 (shown in FIG. 4). In the exemplary embodiment, the method 80 includes, as described in more detail below, impregnating 82 core layers 52 with resin 54 to form a preform (not shown), heating 84 the preform to a first temperature 104, applying 86 a vacuum to the preform, varying 88 an amount of pressure applied to the preform when the temperature reaches the first temperature, heating 90 the preform from the first temperature 104 to a second temperature 108 at a first temperature rate 106, and heating 92 the preform from the second temperature 108 to a third temperature 112 at a second temperature rate 110 to facilitate curing the preform.

In the exemplary embodiment, a composite fan casing 40 is fabricated by creating the preform and then curing resin 54. The preform is initially fabricated by wrapping a fan containment casing mold (not shown) with a mat fabricated from fiber-reinforced layers 52 and resin 54. The mold is used to define a desired size and shape of containment casing 40. In the exemplary embodiment, the mat is then impregnated 82 with additional resin 54 to form the preform. After the preform is formed, in the exemplary embodiment, the preform is then subjected to curing cycle 100. During curing cycle 100, resin 54 is infused substantially uniformly through core layers 52 during an infusion time 122. Infusion time 122 is defined by the period of time between the melting point 138 of resin 54 on the melting curve 134, and the hardening point 140 of resin 54 on the reaction curve 132 as shown in FIG. 5. During resin reaction, in the exemplary embodiment, the resin reacts exothermically. The exothermic reactions produce heat and can undesirably increase the reaction time, thus decreasing infusion time 122.

In the exemplary embodiment, the preform is thermally soaked to a predetermined base temperature 102. Thermal soaking is a known process used to pre-heat large objects, which ensures the entire object is at a uniform temperature. Moreover, in the exemplary embodiment, thermally soaking the preform ensures that each preform begins curing cycle 100 at the same base temperature 102. The pre-determined base temperature 102 is selected to be a temperature that is cooler than the melting temperature of resin 54. Specifically, in the exemplary embodiment, base temperature 102 is variably selected based on the specific chemistry of the resin used. More specifically, in the exemplary embodiment, the base temperature is between about 100° F. to about 160° F. for epoxy resin 54.

After the preform is thermally soaked to pre-determined base temperature 102, in the exemplary embodiment, the preform is inserted into a bag, such as an envelope bag (not shown). The envelope bag is a bag that has at least one opening and at least one vacuum port. Specifically, the envelope bag enables a vacuum pressure to be applied to the interior of the bag.

In the exemplary embodiment, after the preform is inserted in the bag, the preform is heated 84 from pre-determined base temperature 102 to the first temperature 104. The first temperature 104 represents the resin melting point. Generally, the first temperature 104 is variably selected based on the specific chemistry of the resin used. More specifically, in the exemplary embodiment, the first temperature 104 is between about 180° F. to about 210° F. for epoxy resin 54. Moreover, in the exemplary embodiment, an autoclave is used to heat the preform.

Once the preform is heated 84 to the first temperature 104, a vacuum is applied 86 to the preform to facilitate resin 54 being drawn over and into core layers 52, such that the resin substantially backfills encapsulated areas of air that may be formed within the material. In the exemplary embodiment, after the vacuum is applied 86, the preform is heated 90 from the first temperature 104 to the second temperature 108 at the first temperature rate 106. In the exemplary embodiment, the first temperature rate 106 is about 1° F./minute for resin 54. Alternatively, any other rate of resin heating could be used that facilities fabrication of the preform as described herein.

In the exemplary embodiment, varying 88 the external pressure applied to the preform facilitates inducing a plurality of pressure pulses 124 to the preform after the first temperature 104 is obtained. In the exemplary embodiment, the pressure pulses 124 cycle between a first pressure 126 and a second pressure 128. Moreover, in the exemplary embodiment, the first pressure 126 is greater than the second pressure 128. The pressure pulses 124 facilitate compacting and expanding core layers 52. Moreover, the pulses 124 facilitate the extraction of air pockets within the fiber-reinforced material and resin 54. Specifically, in the exemplary embodiment, the application of pressure pulses 124 facilitates the removal of additional air pockets by forcing air out of core layers 52, which is then evacuated through the vacuum. As a result, resin 54 flows substantially uniformly through core layers 52 such that any air pockets are removed and filled with a uniform combination of resin and fiber-reinforced material.

In the exemplary embodiment, the pressure pulses 124 are continually applied to the preform until heated to the second temperature 108. Generally, in the exemplary embodiment, the second temperature 108 represents the beginning of the resin reaction curve 132. Specifically, in the exemplary embodiment, the second temperature 108 is variably selected based on the specific chemistry of the resin used. More specifically, in the exemplary embodiment, the second temperature 108 is between about 270° F. to about 280° F. for epoxy resin 54. After the preform is heated to the second temperature 108, the pressure pulses 124 cease, and a substantially constant pressure 136 is applied to the preform. Furthermore, in the exemplary embodiment, once the preform is heated to the second temperature 108, the preform is then heated to the third temperature 112 at the second temperature rate 110. In the exemplary embodiment, the second temperature rate 110 slows the heating of resin 54 to facilitate lengthening infusion time 122. Generally, in the exemplary embodiment, the second temperature rate 110 is variably selected based on the chemistry of the resin used. In the exemplary embodiment, the second temperature rate 110 is about 0.5° F./minute for resin 54. Alternatively, any resin heating rate may be used that facilitates lengthening infusion time 122 as described herein.

Infusion time 122, in the exemplary embodiment, is further lengthened by heating the preform at a third temperature rate 114. In the exemplary embodiment after the preform reaches the third temperature 112, the preform is heated to a forth temperature 116 at the third temperature rate 114. Generally, in the exemplary embodiment, the third temperature 112 and the third temperature rate 114 are variably selected based on the specific chemistry of the resin used. Specifically, in the exemplary embodiment, the third temperature 112 is between about 290° F. and 310° F. and the third temperature rate 114 is about 0.2° F./minute for resin 54.

In the exemplary embodiment, after the preform is heated to the forth temperature 116, the preform is then heated at a forth temperature rate 118 to a curing temperature 120. Generally, the curing temperature 120 represents the temperature at which resin 54 cures. Specifically, in the exemplary embodiment, the curing temperature 120 is variably selected based on the specific chemistry of the resin used. More specifically, in the exemplary embodiment, the curing temperature 120 ranges between about 325° F. to about 375° F. for resin 54. Moreover, in the exemplary embodiment, curing the preform generally requires the curing temperature 120 to be maintained for a pre-determined period of time that is variably selected based on the chemistry of the resin used. In the exemplary embodiment, the pre-determined curing time for resin 54 is between about 220 minutes to about 260 minutes.

The above-described methods of fabricating a containment system are cost-effective and highly reliable. The methods facilitate reducing air pockets that may form in the resin and/or reinforcing fiber material layers. The engine containment apparatus includes a plurality of reinforcing fiber layers which are each circumscribed by a substantially uniform layer of thermoset resin. During fabrication, a vacuum pressure is applied to the interior of the bag while the preform is sealed inside the bag and the pressure is applied to the exterior of the bag. The combination of the interior vacuum pressure and the exterior pressure applied to the bag facilitates the removal of air pockets within the resin and reinforcing fiber layers, which in turn facilitate enhancing the structural integrity of the containment casing. Accordingly, an engine containment system is provided which facilitates reducing the potential adverse effects of a blade impact event and of foreign object damage in a cost-effective and reliable manner.

Exemplary embodiments of containment assemblies are described above in detail. The containment assemblies are not limited to the specific embodiments described herein, but rather, components of each assembly may be utilized independently and separately from other components described herein. For example, each containment system component can also be used in combination with other containment system components, with other gas turbine engines, and with non-gas turbine engines.

While the invention has been described in terms of various specific embodiments, those skilled in the art will recognize that the invention can be practiced with modification within the spirit and scope of the claims.

What is claimed is:

1. A method for fabricating a turbine engine composite containment casing, said method comprising the steps of:
impregnating a plurality of fiber-reinforced layers with a resin to form a preform;
heating the preform to a first temperature;
applying a vacuum to the preform;
varying an amount of pressure applied to the preform when the temperature reaches the first temperature;
heating the preform from the first temperature to a second temperature at a first temperature rate; and
heating the preform from the second temperature to a third temperature at a second temperature rate to facilitate curing of the preform.

2. A method in accordance with claim 1 wherein heating the preform to the first temperature comprises heating the preform to facilitate reducing the viscosity of the resin.

3. A method in accordance with claim 1 wherein heating the preform comprises heating the preform in an autoclave.

4. A method in accordance with claim 1 wherein varying the amount of pressure applied to the preform comprises cycling the amount of pressure applied to the preform between a first pressure and a second pressure.

5. A method in accordance with claim 1 wherein varying the amount of pressure applied to the preform comprises cycling the amount of pressure applied to the preform between a first pressure and a second pressure, wherein the first pressure is greater than the second pressure.

6. A method in accordance with claim 1 further comprising varying the amount of pressure applied to the preform until the resin is substantially infused into the fiber reinforcing material.

7. A method in accordance with claim 1 further comprising heating the temperature of the preform from the third temperature to a pre-determined temperature to facilitate curing the preform.

8. A method in accordance with claim 7 further comprising maintaining the preform at the cure temperature for a pre-determined period of time.

9. A method in accordance with claim 1 wherein applying a vacuum to the preform comprises inserting the preform into a bag.

10. A method in accordance with claim 9 wherein applying a vacuum to the preform further comprises applying a vacuum to the bag.

11. A composite containment casing for a turbine engine, wherein said casing is fabricated by:
forming a fiber-reinforced mat comprising a plurality of layers of braided reinforcing fibers;
impregnating the fiber-reinforced mat with a resin to form a preform;
inserting the perform into a bag;
heating the bag and perform to a first temperature;
applying a vacuum to the bag and preform;
varying an amount of pressure applied to the bag and preform when the temperature reaches the first temperature;
heating the bag and preform from the first temperature to a second temperature at a first temperature rate; and
heating the bag and preform from the second temperature to a third temperature at a second temperature rate to facilitate curing the preform.

12. A casing in accordance with claim 11 wherein heating the bag and preform to the first temperature comprises heating the bag and preform to facilitate reducing the viscosity of the resin.

13. A casing in accordance with claim 11 wherein heating the bag and preform comprises heating the bag and preform in an autoclave.

14. A casing in accordance with claim 11 wherein varying the amount of pressure applied to the bag and preform comprises cycling the pressure applied between a first pressure and a second pressure.

15. A casing in accordance with claim 11 wherein varying the amount of pressure applied to the bag and preform comprises cycling the pressure applied between a first pressure and a second pressure wherein the first pressure is greater than the second pressure.

16. A casing in accordance with claim 11 further comprising varying the amount of pressure applied to the bag and preform until the resin is substantially infused into the fiber reinforcing material.

17. A casing in accordance with claim 11 wherein curing the resin on the preform comprises heating the temperature of the bag and preform from the second temperature to a pre-determined temperature to facilitate curing the preform.

18. A casing in accordance with claim 17 further comprising maintaining the preform at the pre-determined temperature for a pre-determined period of time.
